(19) United States
(12) Patent Application Publication
(10) Pub. No.: US 2014/0237570 A1
(43) Pub. Date: Aug. 21, 2014

(54) AUTHENTICATION BASED ON SOCIAL GRAPH TRANSACTION HISTORY DATA

(71) Applicant: RAWLLIN INTERNATIONAL INC., Tortola (VG)

(72) Inventors: Rodion Shishkov, St. Petersburg (RU); Dimitry A. Baranov, Moscow (RU)

(73) Assignee: Rawllin International Inc., Tortola (VG)

(21) Appl. No.: 13/768,379

(22) Filed: Feb. 15, 2013

(51) Int. Cl. G06F 21/31

(52) U.S. Cl. CPC G06F 21/316
USPC 726/7

(57) ABSTRACT

Techniques user or user device authentication using data based on social associations and interactions of users or user devices are presented herein. In an aspect, a method includes receiving social graph transaction history data associated with a user identity of a user and contact information associated with the user identity, wherein the social graph transaction history data includes data relating to usage of the contact information for communication between users via respective user devices. The method further includes analyzing the social graph transaction history data, and based on the analyzing, determining a degree of confidence that the user identity is authentic.

### TECHNICAL FIELD

This disclosure relates generally to user or user device authentication using data based on social associations and interactions of users or user devices.

### BACKGROUND

Security mechanisms with respect to various computer based applications and systems are of widespread application. With the proliferation of smartphones and other mobile computing devices into all aspects of personal, business and daily life, the need for more secure data access and transmission is continually evolving. User authentication is central to all computer based security systems. Authentication relates to verifying the identity of someone (e.g., a user, device, or an entity) who wants to access data, resources, or applications. Validating that identity establishes a trust relationship for further interactions. Authentication also enables accountability by making it possible to link access and actions to specific identities.

After authentication, authorization processes can allow or limit the levels of access and action permitted to that entity. As a result, the application will generally request additional input from the user, such as login and password information, in order to authenticate the user. Using passwords is a common method of providing security. However, passwords are easily forgotten and/or discovered by fraudulent entities. Therefore, additional mechanisms of user authentication are of increasing importance.

The above-described deficiencies associated with mobile device authentication are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with user or user device authentication using data based on social associations and interactions of users or user devices are presented herein. In an aspect, a method includes receiving social graph transaction history data associated with a user identity of a user and contact information associated with the user identity, wherein the social graph transaction history data includes data relating to usage of the contact information for communication between users via respective user devices. The method further includes analyzing the social graph transaction history data, and based on the analyzing, determining a degree of confidence that the user identity is authentic.

In another non-limiting embodiment, a system is provided that includes a gathering component configured to receive social graph transaction history data associated with a user identity and associated contact information, wherein the social graph transaction history data includes data relating to usage of the contact information for communication between users via respective user devices. The system further includes a verification component configured to analyze the social graph transaction history data to determine a degree of confidence that the user identity is not a false identity. The contact information can include a mobile phone number or an email address.

In yet another non-limiting embodiment, provided is a tangible computer-readable storage medium comprising computer-readable instructions that, in response to execution, cause a computing system to perform operations, comprising receiving social graph transaction history data associated with a user identity and associated contact information, wherein the social graph transaction history data includes data relating to usage of the contact information for communication between users via respective user devices. The operations further comprising receiving social graph data associated with the user identity, wherein the social graph data includes data defining associations between the user identity and other users, comparing the social graph transaction history data to the social graph data, identifying a correlation or miscorrelation between the social graph data and the social graph transaction history data, and determining a degree of confidence that the user identity is representative of a true user based in part on the identifying the correlation or the miscorrelation.

Other embodiments and various non-limiting examples, scenarios and implementations are described in more detail below. The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates a block diagram of an example system for authenticating a user based in part on social graph transaction history data, in accordance with various aspects and embodiments described herein.

FIG. 2 illustrates an example list of types of social graph data and social graph transaction history data, in accordance with various aspects and embodiments described herein.

FIG. 3 illustrates a block diagram of another example system for authenticating a user based in part on social graph transaction history data, in accordance with various aspects and embodiments described herein.

FIG. 4 illustrates a flow diagram of an example authentication procedure in accordance with various aspects and embodiments described herein.

FIG. 5 is a flow diagram of an example method for authenticating a user based on social graph transaction history data in accordance with an aspect of the disclosed subject matter.

FIG. 6 is a flow diagram of another example method for authenticating a user based on social graph transaction history data in accordance with an aspect of the disclosed subject matter.

FIG. 7 is a flow diagram of an example method for authenticating a user based on social graph transaction history data and social graph data in accordance with an aspect of the disclosed subject matter.

FIG. 8 is a flow diagram of another example method for authenticating a user based on social graph transaction history data and social graph data in accordance with an aspect of the disclosed subject matter.

FIG. 9 is a schematic block diagram illustrating a suitable operating environment in accordance with various aspects and embodiments.

FIG. 10 is a schematic block diagram of a sample-computing environment in accordance with various aspects and embodiments.

### DETAILED DESCRIPTION

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

The subject disclosure presents system and methods for authenticating a user using data related to the user's social connections and social activity. Various mechanisms have been instituted for determining whether an online (electronic or otherwise not in person) user persona can be authenticated to represent a person's true identity. Some known ways for authenticating user's in an electronic environment include usage of a password, a pin code, a digital certificate, an electronic signature, or other form of credible evidence that validates a user's true identity.

The subject disclosure presents systems and methods for authenticating a user or user device using data related to the user's association (referred to herein as a user's social circle) and interaction (referred to herein as a user's social transactions) with others. For example, in a manner similar to which a banking entity analyzes a person's transaction history to determine if his or her credit card has been compromised, the disclosed authentication mechanisms analyze a user's social interactions and associations to determine if the user's identity is verifiable. In an aspect, a user's social interactions and associations are traced via contact information associated with the user (e.g., a phone number or email address) and used to communicate with other users.

In an aspect, social graph data and/or social graph transaction history data is employed in conjunction with authenticating a user. As used herein, the term social graph data refers to information that defines how a person is associated with other people, directly and indirectly. The term social graph transaction history refers to how the person interacts with people in his or her social graph over time, either directly or indirectly. For example, a person will communicate and interact with a network of people on a regular basis, either in person, through telecommunication or online. In an aspect, social graph data for a user can define who the user is associated with, including those who the user communicates and interacts with and those listed in contacts books or linked to the user at a social networking system. Social graph transaction history data can include data pertaining to communications between the user and other users, when the user communicates/interacts with certain other users, how long the user communicates/interacts with certain other users, when the user initially associated with certain other users, relationships between the user and certain other users, and etc.

Social graph data and social graph transaction history data for a user can also include social graph data and social graph transaction history data for other users indirectly linked to the user in his social graph. According to this aspect, a user's social graph can include people linked to one another by various degrees of separation (e.g., where user A communicates with user B who communicates with user C, user A is linked to user C by one degree of separation). For example, a user's social graph transaction history data can include information pertaining to direct communications/transactions between the user and anther user included in his or her social graph and indirect communications/transactions between the user and other user in his or her social graph. According to this example, a user's social graph transaction history data can include information mapping the user's direct communication with a first set of people, information mapping respective people in the first set of people to additional sets of people, information mapping respective people in the additional sets of people with yet further additional sets of people and so on.

The disclosed social authentication mechanisms rely on the observation that an individual's social affiliations and social activity, when acting on his or her own behalf, reflect traceable patterns and trends. For example, a particular person will likely have an identifiable group (e.g., a direct social circle) of people that they regularly communicate with (e.g., via calling, texting, emailing and etc.). Those people included in the user's direct social circle will also have unique identifiable groups of people that they communicate with. Accordingly, when a fraudulent entity has obtained information representative of another person's identity (e.g., mobile number, email address and etc.) and employed the information for fraudulent transactions, the social activity and/or social affiliations of the fraudulent entity will contradict that of the true persons. For example, where a true person's mobile phone number has been confiscated by a fraudulent entity, the outgoing calls from the phone to the true persons regular friends may stop. Similarly, the fraudulent entity may receive calls from irregular or unrecognized numbers and/or the entities associated with the unrecognized numbers may have unconventional social circles. These types of patterns can indicate that the mobile number of the true user has been confiscated and thus when the fraudulent entity attempts to employ the mobile number for authentication purposes, an authenticating system can deny authentication. Similarly, if a fraudulent entity employs a fake name, number, or other form of identification that is not representative of a real person, the social associations and/or interactions associated with the fraudulent entity will not resemble those of a real person.

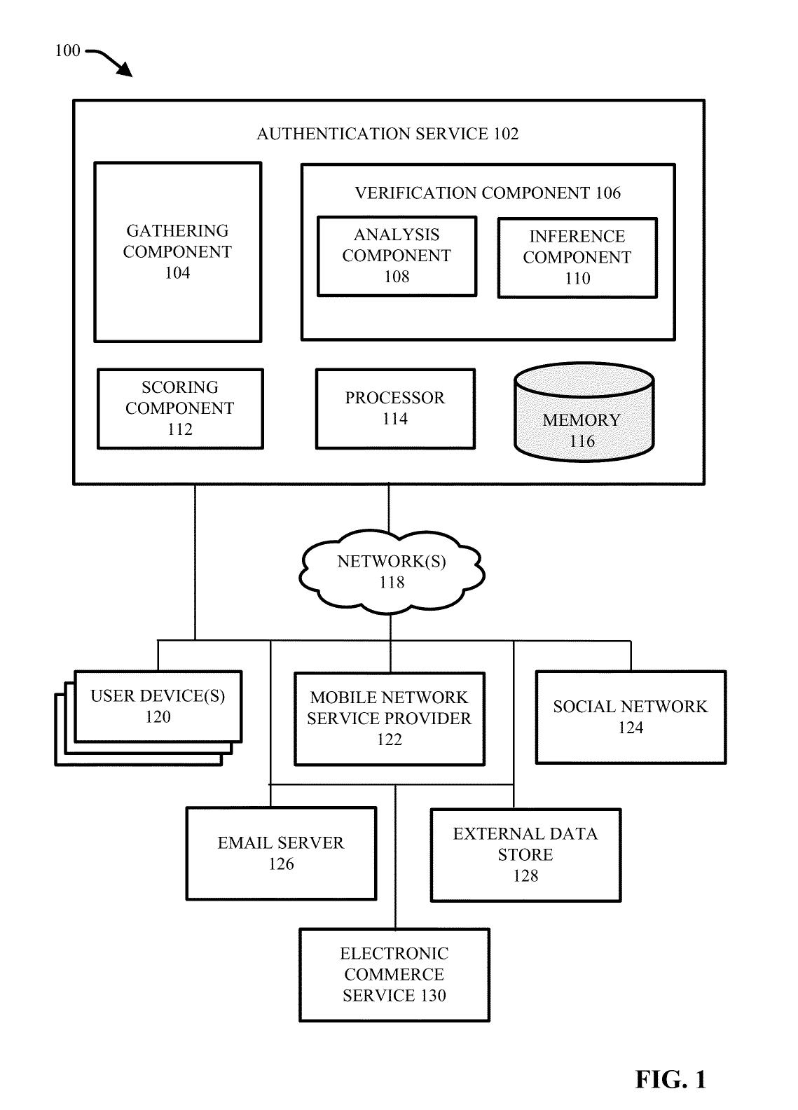

Referring now to the drawings, with reference initially to FIG. 1, presented is a system 100 for authenticating a user in accordance with aspects described herein. System 100 includes an authentication service 102 that facilitates authenticating an identity of a user. Aspects of apparatuses, systems or processes explained herein can constitute machine-executable components embodied within machine(s), e.g., embodied in one or more computer readable mediums (or media) associated with one or more machines. Such components, when executed by the one or more machines, e.g., computer(s), computing device(s), virtual machine(s), etc. can cause the machine(s) to perform the operations described.

Authentication service 102 can include one or more computers connected in a networked environment and configured to authenticate a user using various mechanisms as described herein. Authentication service 102 includes memory 116 for storing instructions (e.g., computer executable components and instructions). The authentication service 102 further includes a processor 114 to facilitate operation of the instructions (e.g., computer executable components and instructions) by the authentication service 102.

Authentication service 102 is configured to analyze authentication data that constitutes authentication evidence to facilitate authenticating an identity of a user. Authentication service 102 can analyze various types of authentication data to facilitate authenticating a user including traditional types of data (e.g., passwords, pin numbers, digital certificates, electronic signatures, private keys, and etc.) as well as social graph data and social graph transaction history data. In an aspect, some or all of the authentication data is generated by the authentication service and stored in memory 116. In another aspect, some or all of the authentication data is provided to the authentication service 102 by an external source. For example, the authentication service 102 can receive or extract authentication evidence from various external sources including but not limited to users (via user devices 120), user devices 120, an email server 126, a mobile network provider 122, an external data store 128, or a social network 124. In an aspect, the authentication service 102 is directly linked and/or integrated with one or more external sources 120-128. For example, a mobile network service provider, a social network system 124, a system requiring authorization (e.g., a banking system) or an authorization system 122 can include authentication service 102.

In another aspect, authentication service 102 can access various external sources 120-128 and/or be accessed by various external sources via one or more networks 118. The one or more networks 114 can include but are not limited to a cellular network, a wide area network (WAD), or a local area network (LAN). For example, authentication service 102 can communicate with external devices and/or sources using virtually any desired wireless technology, including, for example, cellular, WAN, wireless fidelity (Wi-Fi), Wi-Max, WLAN, and etc.

Devices, such as user devices 120, capable of employing system 100, can include any suitable computing device configured to communicate with authentication service 102. In an aspect, user devices 120 are mobile devices such as a cellular phones or smartphones (e.g., a 3GPP or 4GPP Universal Mobile Telecommunications System (UMTS) phone). Devices 120 can further include but are not limited to, an electronic notebook, an electronic pad or tablet, an electronic gaming device, a personal digital assistant (PDA), a laptop computer, a desktop computer or a set-top box, that can operate and communicate in a communication network 118 environment. In an aspect, user's for whom identity is verified by authentication service 102 communicate with authentication service either directly or indirectly (e.g., via a third party such as an entity requesting authentication of the user) via a user device 102.

As used in this disclosure, the terms “user” or “content consumer” refers to a person, entity, system, or combination thereof that employs system 100 (or additional systems described in this disclosure). In the context of user authentication, a user refers to a person or entity identifiable to a computing system by an assigned identity identification, such as a name or number. Authentication of the user is a process for determining whether a user is in fact the person, as defined by the name or number, he or she declares to be. The term “true user” or “true entity” refers to a user who is in fact who they claim to be. The term “false/fraudulent user” or “false/fraudulent entity” refers to a user who is not in fact who they claim to be.

In order to facilitate proving identity to various systems, authentication services (e.g., service 102) can require a user to provide a password or digital certificate to authenticate himself. In an aspect, service 102 facilitates authenticating a user by examining social graph data and/or social graph transaction history data affiliated with a user identity to determine whether the user identity represents a true user or a fraudulent entity. In particular, fraudulent entities will not be able to generate social graph data and/or social graph transaction history data that is consistent with a true user. For example, a fraudulent entity will likely be unable to generate authentication evidence that reflects associations with other users across various databases (e.g. contact books and social networking sites) that are consistent with the true user's associations. Similarly, a fraudulent entity will likely be unable to generate authentication evidence that indicates interaction with other users over a period of time that is consistent with the true user's social transactions.

In an aspect, authenticating service 102 tracks a user's interaction and association with other users using contact information, such as a phone number or email address, associated with the user. With this information, authenticating service 102 can examine communications between a user identity, claiming to be associated with the contact information, and other users to identify patterns in the communication history that reflect association of the phone number to a real person and further to a true user. For example, a user, John Smith can claim that he is assigned to or otherwise tied to phone number 440-696-0622. In an aspect, phone history data that reflects minimal or no phone activity or only outgoing calls could be indicative of a fake phone number that is not associated to a true user, and thus not associated with a John Smith. In another example, phone history data that reflects a sufficient change in usage at an identifiable period of time could reflect disassociation of the phone number from John Smith. According to this example, authenticating service 102 can discern that outgoing and incoming texts and calls to and from phone number 440-696-0622 sufficiently stopped for a period of time, and after resuming reflected patterns that contradicted previous usage, reflecting a likelihood that the phone number 440-696-0622 is no longer associated with the real John Smith, but confiscated by a fraudulent entity.

In order to better associate social graph transaction history data (e.g., as discerned from phone history data or emailing history data) to a particular person, authenticating service 102 can compare social graph transaction history data to social graph data associated with the particular person. In this respect, the authenticating service 102 can compare social graph transaction history data with social graph data to determine whether the social graph transaction history data for a user identity is consistent with the social graph data for the user identity. For example, the authenticating service 102 can determine whether the phone history data associated with number 440-696-0622 includes communications between user's that are known to be included in John Smith's social graph. In another example, the authenticating service 102 can determine whether the phone history data associated with number 440-696-0622 includes communications between user's that are consistent across multiple data sources reflecting associations for John Smith (e.g., phone history includes contacts to persons A, B, and C, John Smith has contacts A, B, C listed in contacts book, John Smith has contacts A, B, and C listed as friends on a social networking site, John Smith has contacts A, B, and C listed in an online email address book, and etc.).

According to this aspect, the authenticating service 102 can have previously stored information representative of a user's social graph and/or determine or infer a user's social graph information. For example, authenticating service 102 can have or receive knowledge of the people that John Smith is associated with. In an aspect, this knowledge can be extracted or received from contacts files associated with phone number 440-696-0622, online address books associated with John Smith and/or phone number 440-696-0622, email address books associated with John Smith and/or phone number 440-696-0622, and/or social network affiliations associated with John Smith and/or phone number 440-696-0622. Similarly, the authenticating service 102 can determine or infer that an accurate or believable social graph cannot be generated from available information, thus indicating association of the contact information with a fraudulent entity.

Referring back to FIG. 1, to facilitate authenticating a user, authenticating service 102 can include gathering component 104, verification component 106 and scoring component 112. Gathering component 104 is configured to gather authentication data, such as social graph data and social graph transaction history data, associated with a user. For example, a user can declare that he or she is John Smith and provide authentication service 102 contact information that represents John Smith (e.g., a phone number or email address) that can be employed by gathering component 104 to collect social graph data and/or social graph transaction history data for John Smith. In some aspects, the user can provide additional information that can be employed by gathering component 104 to collect social graph data and/or social graph transaction history data for the user identity. For example, the user can provide social network profile names, other usernames employed by the user, other identification names/numbers associated with the user and/or account names and numbers.

Verification component 106 is configured to analyze the authentication data and to make various determinations regarding whether a user identity is representative of the true user or a fraudulent entity. In an aspect, the verification component 106 generates a social graph and/or a graph representative of a user's social graph transaction history to facilitate making various determinations regarding whether a user identity is representative of the true user or a fraudulent entity. The verification component 106 can further determine a degree of confidence to which a user identity is representative of a true user based on the analysis conducted. Scoring component 112 can then generate a score to associate with the user identity/contact information that reflects the degree of confidence that the user identity is representative of the true user.

In an aspect, gathering component 104 is configured to gather or receive social graph data and/or social graph transaction history data associated with a user identity (e.g., John Smith) using associated contact information (e.g., phone number 772-696-0622) for the user identity and/or any other additional information that represents the user identity (e.g., email address, profile names, and etc) provided by the user (e.g., via a user device 120) or extracted from various sources. As defined above, social graph data can include any data defining relationships between a user and other users while social graph transaction history data can include any data defining interactions between a user and other users. In an aspect, social graph data for a user is previously associated with authenticating service 102 and stored in memory 116. In another aspect, social graph data for a user is gathered by gathering component 104 from various external sources 120-122.

In an aspect, social graph data for a user can include direct contacts listed in a contact file associated with a phone number or email address associated with the user or user device of the user. For example, a user device 120 associated with a phone number claimed to be associated with a user identity (e.g., name John Smith) can include a mobile phone that has stored thereon, a list of mobile contacts associated with the user identity, including names and numbers for those contacts. According to this example, the gathering component 104 can extract the contacts list from the user device 120. In another aspect, the mobile contacts file can be held at a data store affiliated with a mobile network service provider 122 or external data store 128. According to this aspect, the gathering component 104 can extract the contacts list from the mobile network service provider 122 or external data store 128.

Social graph data for a user can further include indirect contacts associated with people listed in the contacts file (e.g., those people associated with a user by various degrees of separation). For example, in addition to receiving a contacts file for a phone number associated with a user who's identity is in question, gathering component 104 can receive contact files for each of the user's (e.g. from each of the user's devices, an external data store or mobile network service provider) listed in the contacts file of the user who's identity is in question. As discussed infra, the verification component 106 can compare contacts listed in respective contact files to identify correlations between the respective contacts files that appear irregular.

Social graph data for a user can further include people associated with a user who's identity is in question as determined from additional information otherwise accessible to gathering component 104 (e.g. via network 118) that links the user to other people. For example, gathering component 104 can access a user's email contacts stored at an email server 126, or a user's Internet based contacts stored at an internet communication service (e.g., Skype™). In another example, gathering component 104 can scan various external open source databases (e.g., external data stores 128) that associate a user's name and/or contact information with other people. According to this example, a user's name and/or contact information could be listed on a roster for a sports team, educational group, or workplace along with other people respectively listed.

Further, the gathering component 104 can receive social graph data from various social networks 124. For example a user who's identity is in question may belong to one or more social, personal, or professional networking websites that allow the user to create a profile and associate themselves with various other individuals belonging to the respective networking websites. As used herein, users associated with one another at a social, personal or professional networking website are referred to as “friends.” According to this aspect, the gathering component 104 can receive information from such networking sites that indicates who a user's friends are.

In an aspect, social graph data can include additional rich information defining relationships between a user and anther user aside from a mere indication that the two individuals are linked. For example, such additional information can relate to how long the user and another person have been associated or been friends, whether the user and the other user are directly linked or linked by one or more degrees of separation, and whether the user and the other user are friends, relatives, colleagues, acquaintances or lovers, and etc. For example, when identifying people listed in a user's mobile contacts list, the gathering component 104 can further receive information indicating how recent respective people were added to the contacts list. In another example, when identifying people listed as friends of a user on a social networking profile of the user, the gathering component 104 can receive information indicating recency of addition of the respective friends to the user's social networking profile.

Social graph transaction history data can include any data pertaining to interactions between a user who's identity is in question other users in the user's social circle. In an aspect, social graph transaction history data includes data related to communications between users using contact information for the respective users that facilitates communication over a network (e.g., a telecommunications network or an Internet based network). In another aspect, social graph transaction history data can include information related to electronic data transfers between user's, including money transfers. For example, electronic data transfers between user's can be traced as a function of at least one of user identification information, user contact information, or user account information.

In an aspect, social graph transaction history data includes information included in a user's phone records. In an aspect, this information can define communications sent from a user's mobile phone number and received at the users mobile phone numbers. For example, a user's phone records can reveal who a user calls, when the user places the calls, and the duration of the calls. Similarly, a user's phone records can reveal who calls the user, when the user receives calls, and the duration of received calls. A user's phone records can further defined information pertaining to those user's who a user sends text or multimedia messages to, who a person receives text or multimedia messages from, times at which messages are received and sent, frequency of messages, and etc.

Social graph transaction history data for a user who's identity is in question can further include phone records for respective user's associated with the user in the user's social graph. For example, where a user sends and receives cellular communications between a first set of users, social graph transaction history data for the user can further include respective phone records for each of the user's included in the first set. In an aspect, the gathering component 104 can receive phone history data associated with a user's phone number from a user device 120 associated with the phone number. In another aspect, the gathering component 104 can receive phone history data for a particular phone number from a mobile network service provider 122 servicing the phone number.

Social graph transaction history data can further include email records associated with a user who's identity is in question. According to this aspect, gathering component can collect information from an email server 126 and/or a user device 120 indicating who a user has sent emails to, the frequency of emails sent to certain people, who a user has received emails from, the frequency of emails sent, and data transfers associated with sent and/or received emails. According to this aspect, the gathering component 104 can track a user's emails records using at least one of a user's identification information (e.g., name or ID number), a user's phone number, and/or a user's email address. This information can be provided to authentication service 102 (e.g., by a user via a user device) and/or determined by authentication service 102.

Furthermore, social graph transaction history data for a user can include information defining data transfers between the user and another user, referred to herein as peer to peer data transfers. In an aspect, peer to peer data transfers include monetary transactions between users. According to this example, the gathering component 104 can collect information that defines who a user has transferred money to, who a user has received money from, the frequency of money transfers and the amount of money associated with a money transfer.

In an aspect, data transfers, including monetary transfers, are effectuated between users using mobile phone transmissions. According to this aspect, the gathering component 104 can trace peer to peer data transmissions as a function of a user's mobile phone number. For example, the gathering component 104 can collect information from a user device and/or a mobile network provider that defines monetary transfers between users. In another aspect, the gathering component 104 can collect information relating to monetary transfers between users using information stored by an electronic commerce service 130 that facilitates the monetary transfers.

In another aspect, the gathering component 104 can further receive information pertaining to the mechanism of a peer to peer data transfer. For example, the gathering component 104 can receive information that indicates whether a money transfer was effectuated using a personal area network (PAN) (e.g., using near field communication or other short range communication technology) or local area network (LAN) or wide area network (WAN). According to this aspect, where a user transfers data, such as funds, to another user using near field communication, the user and the other user will have been within close physical proximity of one another, indicating a higher degree of intimacy between the users and the particular transaction.

The verification component 106 is configured to analyze social graph data and social graph transaction history data for a user identity to determine a degree of confidence to which the user identity is representative of a true user. In an aspect, the verification component 106 can employ analysis component 108 and/or inference component 110 to facilitate making various determinations and inferences regarding a user's identity based on social graph data and/or social graph transaction history data for the user.

The analysis component 110 can employ one or more algorithms and/or look-up tables stored in memory 116 to facilitate making various determinations and inferences regarding whether a user identity can be authenticated. Such algorithms and/or look-up tables can relate various patterns in social graph transaction history data and/or social graph data to user authenticity. For example, a pattern in social graph data that reflects consistent sets of associated users across various accounts and data stores can indicate authenticity of a user. In addition, such algorithms and/or look up tables can define relationships between social graph data and social graph transaction history data for a user identity that reflect authenticity of the user identity. For example, such algorithms and/or look up-tables can relate a degree to which a user interacts with people included in his or her social graph to user authenticity. In another example, such algorithms and/or look-up tables can factor the quality and nature of user interactions with people included in the user's social graph to facilitate determining user authenticity.

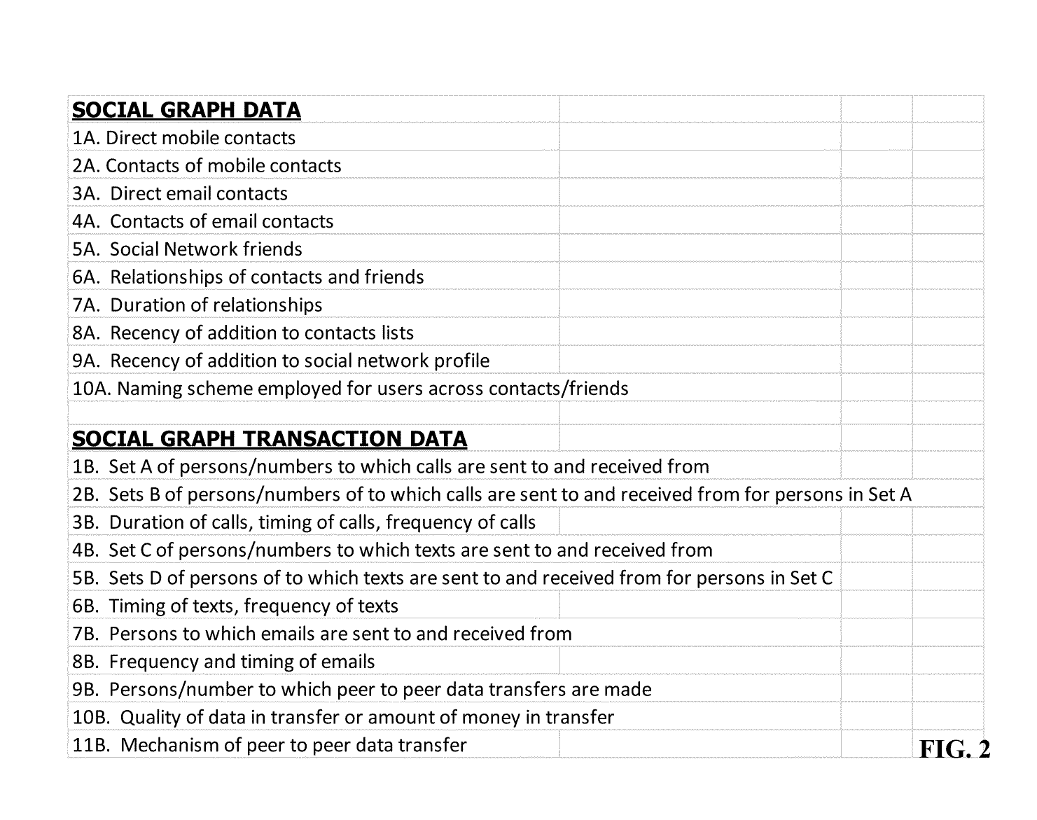

Referring ahead to FIG. 2, presented is an example list of types of data that can be included in social graph data and social graph transaction history data for a particular user. Items 1A-10A include social graph data and items 1B-11B include social graph transaction history items. It should be appreciated that the various items listed in FIG. 2 are not exhaustive of all possible social graph data and social graph transaction history data items. Further, items listed as social graph data and social graph transaction history data can be interchanged in some aspects. For example the set of persons/phone number to which calls are sent to and received from, (item 1B), could define a set of people the user is associated with and thus constitute social graph data under the definition for social graph data employed herein. The analysis component 108 and/or inference component 110 is configured to employ one or more algorithms that output information indicating a degree of confidence to which a user identity is representative of a true user as a function of one or more items 1A-1B and items 2A-2B.

In an aspect, patterns in social graph data for a user can factor into whether a user identity is representative of a true user. Patterns in social graph data can include patterns related but are not limited to: overlap of user friends/contacts across two or more data sources, consistent usage of a name with respect to identifying information across two or more data sources (e.g., number 772-696-0622 is listed in various mobile phone contact lists with the name John, John Smith, John S. Johnny, Jon, or J. S), degrees of overlap between a user's friends/contacts and friends/contacts of the user's friends/contacts, timing of addition of mobile contacts to a user's mobile contacts list, timing of addition of social network friends to a user's social network profile, and timing of addition of mobile contacts with respect to timing of addition of friends. For example, an indication that a user identity is a fraudulent entity could be evinced from a pattern wherein none of a user's mobile contacts are associated with the user in another data source.

In another aspect, patterns in social graph transaction history data can factor into whether a user identity is representative of a true user. Patterns in social graph transaction history data can include patterns related to but not limited to: changes in persons/number to which calls are sent to and received from over a period of time, changes in durations of the calls, changes in persons/number to which texts are sent to and received from over a period of time, persons included in set A and sets B, persons included in set C and sets D, changes in timing and frequency of calls and texts, changes of persons to which emails are sent to and received from over time, and changes in frequency and timing of emails. For example, an indication that a user identity is a fraudulent entity could be evinced from a pattern in phone history wherein calls and texts received from regular contacts are not answered repeatedly over a period of time while calls are sent and received from new or unrecognized numbers over the same period of time.

The analysis component 108 and/or inference component 110 can further determine and/or infer authenticity of a user based on comparison of social graph data with social graph transaction history data for the user. Such comparison can facilitate determining whether a user's social interactions, as evinced in phone records, email records and/or peer to peer data transaction records, are reflective and consistent with a user's social graph data. According to this aspect, the authentication service 102 gathers social graph data for a user or otherwise previously has knowledge of a user's social graph data (e.g., stored in memory) for comparison with social graph transaction history data for the user. The analysis component 108 can then compare a user's social graph data to the user's social graph transaction history data (e.g., phone history data associated with a phone number associated with the user, email history data associated with an email address of the user and/or peer to peer transaction history data associated with phone number or account number for the user) to determine whether the social graph transaction history data is consistent with the social graph data. For example, the analysis component 108 can analyze who the user communicates with and whether these people are part of the user's social graph as well as who a user transfers and receives money from and whether these people are consist with the user's social graph.

In an aspect, to ensure that the social graph transaction history data reflects the activity of a true user (and not a fraudulent entity attempting to mock up transaction history data by impersonating the true user) the analysis component 108 and/or inference component 110 can weigh social transaction history data based on various factors including but not limited to: the duration of a phone call, the frequency of communication with a particular person, the recency of association of the user with a person communicated/transacted with, the type of association of the user with a person communicated/transacted with (e.g., relative, friend or lover), how many different lists/data sources affiliate the user and a person communicated/transacted with, and the quality and/or quantity (e.g., monetary amount) of peer to peer data transfer between the user and a person communicated/transacted with.

For example, a fraudulent entity may misappropriate a user's cell phone and attempt to present himself as John Smith to a system requiring user authentication prior to authorization as evinced by the phone number associated with the phone and the real John Smith. In order to generate transaction history data that is reflective of the real John Smith (so that the fraudulent entity can pass for the real John Smith by way of verification by social graph/social graph transaction history data), the fraudulent entity may look through old call history stored in the phone and/or contacts stored in the phone and send mock calls to some of the people the real John Smith previously communicated with. In order to catch such impersonators, the analysis component 108 can set minimum requirements before certain transaction history is considered meaningful (e.g., call history is meaningful for: persons communicated with over a minute, persons associated with a users contacts list over a month, persons to which money transfers were greater than $100, persons associated with the user in a contact list and social network profile over a month, and etc.).

In an embodiment, the verification component 106 can include an inference component 110 to facilitate making inferences in connection with determining a degree of confidence to which a user identity is representative of a true user. For example, the inference component 110 can infer patterns indicative of a true user and patterns indicative of a fraudulent entity reflected in social graph transaction history data or social graph data. In another aspect, the inference component can infer correlations and/or miscorrelations between a user's social graph data and social graph transaction history data.

In order to provide for or aid in the numerous inferences described in this disclosure, inference component 110 can examine the entirety or a subset of data to which it is granted access in order to provide for reasoning about event management and planning decisions. Inference component 110 can be granted access to any information associated with system 100 (and additional system described herein), including information received or generated by system authentication service 102, information stored in memory 116, as well as accessible extrinsic information accessible to authenticating service 102 via a network 118.

Inference component 110 can perform inferences to identify a specific context or action, or to generate a probability distribution over states, for example. The inferences can be probabilistic—that is, the computation of a probability distribution over states of interest based on a consideration of data and events. An inference can also refer to techniques employed for composing higher-level events from a set of events or data. Such inference can result in construction of new events or actions from a set of observed events or stored event data, whether or not the events are correlated in close temporal proximity, and whether the events and data come from one or several event and data sources. Various classification (explicitly or implicitly trained) schemes or systems (e.g., support vector machines, neural networks, expert systems, Bayesian belief networks, fuzzy logic, data fusion engines, etc.) can be employed in connection with performing automatic or inferred action in connection with the claimed subject matter.

A classifier can map an input attribute vector, x=(x1, x2, x3, x4, xn), to a confidence that the input belongs to a class, such as by f(x)=confidence(class). Such classification can employ a probabilistic or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used in this disclosure also is inclusive of statistical regression that is utilized to develop models of priority.

In view of the above processing techniques described with respect to the verification component 106, one example application of authentication service 102 includes determining whether a subject's telephone number is an active number or obtained for a fraudulent transaction and intended to assist in concealing true identity of a person. For example, the verification component 106 can construct graphs of contacts per incoming and outgoing calls of a user who is attempting to claim he is John Smith as evinced by his phone number. Essentially, each true live person would have circle of regular contacts, and each of these regular contacts, in turn, would have their own circle of regular contacts. The verification component 106 can analyze whether the phone history associated with the phone number reflects regular patterns of communication by John Smith to facilitate determining user authenticity. The verification component 106 can further weight calls conducted over a predetermined period of time (e.g., 1 minute, 3 minutes and etc.) to circumvent false positives associated with a scenario in which the user dedicates time and effort towards making mock up calls to others in an effort to conceal his or her identity.

Also, to confirm that the user has not made calls to other mock up phone numbers, the verification component 106 can analyze the outgoing and incoming calls of the user's contacts. For example, if the circle of friends of the user and the circles of friends for each friends of the user are the same (e.g., same names and/or numbers) the verification component 106 can infers such evidence is an indication of possible fraudulent accounts. In other words, the social graph and/or social transaction history data of a user should reflect a “5-degree separation rule” where and each subsequent friend needs to know at least someone whom the others do not know.

Additionally, the verification component 106 could examine consistency in which a user's name is recorded in friends phonebooks or address books. For example, a suspicion of masking identity with fraudulent intent could be the information of inconsistency of subject's name under which it is recorded in friends address or phonebooks. According to this example, where someone presents himself as John Smith, if the name associated with the same phone number provided to the authentication service 102 by the alleged John Smith is recorded in most friends phone books as John or Jonny, or Jon, etc., and only a small percentage of people have him recorded as Steve or Jack, the percentile of error is acceptable. On the other hand, if the name associated with the number presented by the alleged John Smith is recorded in various phonebooks and/or address books under a plurality of different names (e.g., a distribution greater than over 75%) this is considered to be suspicious and factored by the verification component 106 when determining authenticating the user.

Referring back to FIG. 1, in an aspect, authentication service 102 can include scoring component 112 to apply a score to a user identity that reflects authenticity. The authentication service 102 can further store the user identity and associated score in memory 116. In an aspect, the score can reflect user authenticity based on the degree of confidence the verification component 106 determines or infers a user identity to be that of a true user as a function of social graph data and/or social graph transaction history data. As used herein, such a score is deemed a user's social trust score.

In particular, based on the various social graph data and social graph transaction history data analysis techniques of the verification component 106 discussed above, the verification component 106 can output information indicating a degree of confidence to which the authenticating service 102 deems a user identity to be representative of a true user, (or otherwise verified). For example, the verification component 106 can output a degree of confidence ranging from 0.0% to 100.0%, where 0.0% indicates that the authentication service 102 has no faith that the user is authentic and 100.0% indicates that the authentication service 102 has complete faith that the user is authentic. According to this example, the scoring component 112 can associate a social trust score with the user identity that reflects the confidence level determined or inferred by the verification component 106. In an aspect, the score can be the same number as the confidence level (e.g., a confidence level of 65% can result in a social trust score of 65). In another aspect, the scoring component 112 can apply one or more look up tables stored in memory 116 that equate a confidence level to a non-numerical score (e.g., A, A−, B, B−, C, and etc., or Platinum, Gold, Silver, Bronze, and etc.).

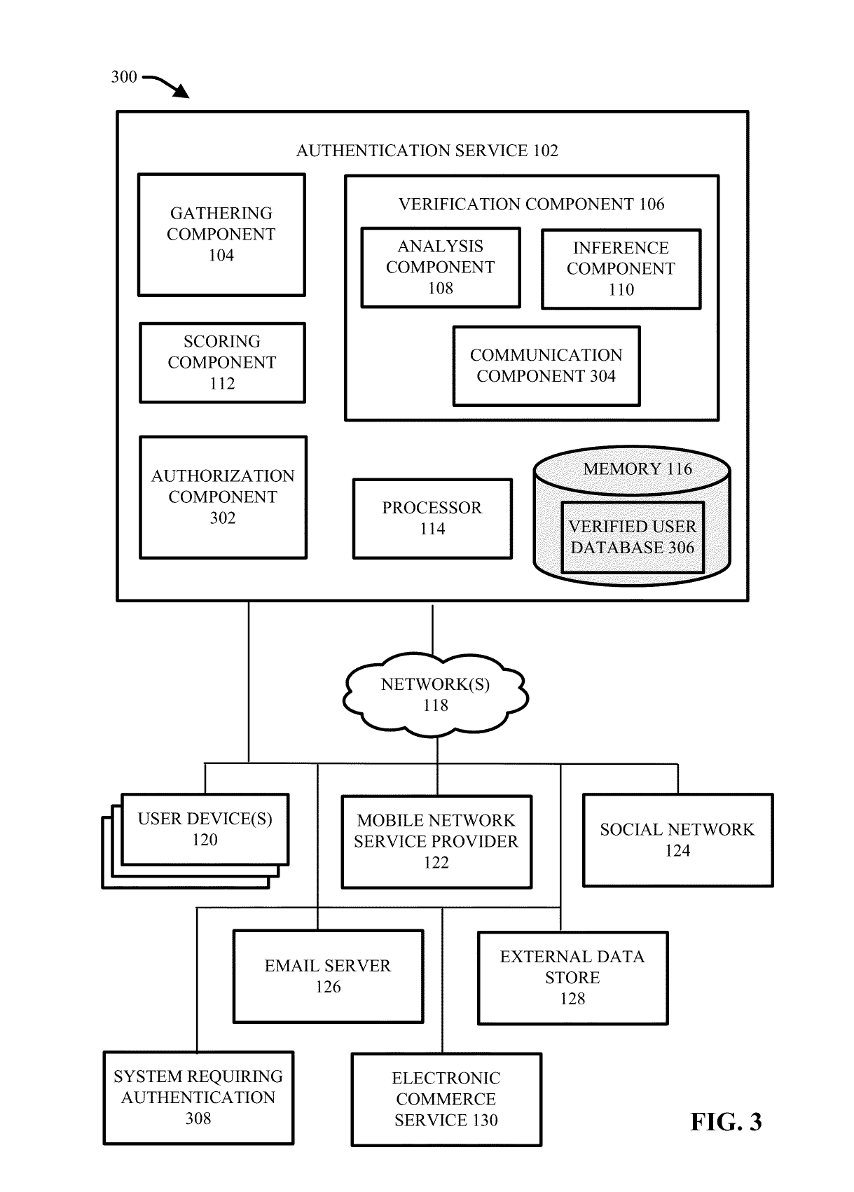

Referring now to FIG. 3, presented is another system 300 for authenticating a user in accordance with aspects described herein. System 300 is similar to system 100 with the addition of various components to the authenticating service 102. In particular, in system 300 the authenticating service 102 further includes authorization component 302 and the verification component 106 further includes communication component 304. Repetitive description of like elements employed in respective embodiments of systems described herein are omitted for sake of brevity.

In an aspect, communication component 304 facilitates an additional mechanism for authenticating a user that can be employed by authenticating service 102, verification by another user. In particular, communication component 304 can be employed by the verification component 106 to communicate with users, who were previously authenticated by authentication service 102 and whom may know a user who's identity is in question for the purpose of receiving a surety of the user's identity. For example, after authenticating service 102 has verified the identity of a user, the authenticating service 102 can store information pertaining to the verified user in memory 116 with an indication that the user has been verified. The authenticating service 102 can store a verified user's name and contact information (and any other information received or generated by authenticating service 102 representative of the user's identity such as usernames, account number, digital certificates, and etc.).

As a mechanism for verifying a user's identity, the verification component 106 can identify one or more persons affiliated with the user who's identity is in question and who were previously authenticated by authenticating service 102. For example, the verification component 106 can search through a user's phone contacts, email contacts, and/or social networking friends to identity one or more persons included in those contact files who are known to the authenticating service as verified users (as stored in memory 116). The communication component 304 can then generate one or more messages posing a question as to whether the one or more verified user can verify the identity of the user who's identity is in question. The communication component 304 can then send the one or more messages to the one or more verified users and receive one or more response messages from the one or more verified users answering the question posed. The verification component 106 can then analyze the response messages received to facilitate determining whether the user who's identity is in question can be verified. For example, the verification component 106 can generate a message that asks whether verified person “Amy” knows “John Smith” and whether she can verify that John Smith's phone number is 772-696-0622. The message can further prompt Amy to respond with a response indicating whether in fact she knows John Smith and whether the number listed is his correct number.

The communication component 304 can employ various known communication methods for generating, sending and receiving verification messages. In an aspect, the communication component 304 generates a messages and communicates to a verified user using the contact information stored for the verified (e.g., phone, email, or both). In some aspects, the verification message is a text message and allows a verified user to respond using a text message. It should be appreciated that communication component 110 can employ an external (or internal) email service, text messaging service, or phone service, to facilitate generating, sending and receiving verification messages.

In an aspect, received verification messages are employed by the verification component 106 when determining the degree of confidence to which the authenticating service 102 believes a user identity is representative of a true user. According to this aspect, the scoring component 112 can generate a social trust score for a user that reflects surety by a friend responses. It should be appreciated that multiple verified users can offer a surety of another user's identity. Accordingly, the number of verified users who verify another user's identity can further factor into the user's social trust score.

In another aspect, the surety by a known user aspect of authenticating service 102 can serve as a separate indicator from a social trust score, as to the authenticity of a user. According to this aspect, a user could have a social trust score and an indication that he or she has also been verified by a known user (or a plurality of known users). For example, authentication service 102 can output information indicating that John Smith has a social trust score of 85% and that he has been verified by 3 other verified users. Further, authenticating service 102 could forgo the usage of social graph data and/or social graph transaction history data with respect to the generation of a social trust score and merely employ the graph data and/or social graph transaction history data find friends of the user for surety verification purposes alone.

In an aspect, information pertaining to a user's social trust score and/or verification by one or more other users is stored by authenticating service 102 in memory 116 (e.g., in a verified user database 306). For example, authenticating service 102 can provide a searchable and trustworthy database 306 of verified users that can be employed by other systems to quickly authorize a user based on the verification information associated with the user in the searchable database. In some aspects, the database can indicate various levels of identity verification applied to the user by authentication service 102 and respective scores or insignia associated therewith. For example, a verified user in database 306 can be associated with a social trust score, and an insignia that indicates he or she has been verified by a friend.

Further, in addition to user authentication using social graph and/or social graph transaction history data and surety by a friend techniques, the authentication service 102 can facilitate authenticating a user using other authentication mechanisms. For example, the authenticating service 102 can verify a user using existing mechanisms, including but not limited to: verification using a password, verification using a digital certificate, or verification using a private key. According to this aspect, authorization based on a social trust score and/or surety by a friend can supplement other authorization mechanisms (and vice versa), contributing to a stronger cumulative method of authenticating a user. In addition, according to this aspect, the authenticating service 102 can associate a user with information indicating the multiple ways in which the user has been verified by authentication service 102. For example, a user could be assigned various insignia that reflect the degrees in which he or she has been verified by authentication service 102 (e.g., platinum trust insignia can indicate a high social trust score plus verification by two or more friends, plus verification by a digital certificate).

In an aspect, an external system requiring user authentication prior to authorization 308 can employ verification service 102 to verify a user. For example, such an external system can employ database 306 to determine if a user who is requesting authorization by the external system has been previously authenticated by the authenticating system 102. In another aspect, the external system 308 could receive a request by a user to gain access to the external system. The external system can then request user authentication prior to providing access and employ authentication service 102 to facilitate authenticating the user. For example, the external system 308 can request a user provide his or her contact information and name (or other identifying information such as a user name, password, digital certificate and etc). The external system 308 can then pass the user's contact information and name onto the authenticating service 102 for authentication of the user in one or more of the manners described herein (e.g., via a social trust score, via surety by a friend, via a password, via a digital certificate and etc.)

In an aspect, authentication service 102 can output information indicating verification of a user (e.g., a social trust score) and provide this information to the system requiring authentication 308. In another aspect, the authentication service 102 can include an authorization component 302 that determines whether a user can be authorized by a system based on verification information determined for the user. According to this aspect, the authorization component 302 can analyze verification information (e.g., a social trust score) to determine whether the verification information qualifies the user for authorization. For example, the authorization component 302 can authorize a user who's social trust score is above a predetermined threshold and decline authorization of a user who's social trust score is below a predetermined threshold. In another example, the authorization component 302 can authorize a user who's social trust score is above a predetermined threshold and has provided a digital certificate and decline authorization of a user who's social trust score is below a predetermined threshold yet who has provided a digital certificate.

In an aspect, the authorization component 302 can apply different authorization thresholds depending on the system 308 employing the authentication service 102. For example, an external system 108 can apply internal thresholds of verification prior to allowing a user authorization and provide these internal thresholds to authorization component 302 for application thereof. According to this example one external system could require a user to have a social trust score of 90 or higher while another external system could require a user have a social trust score of 99 or higher. According to this aspect, various different external systems can employ authentication service 102 according to their individual needs. In another aspect, the authorization component 302 can apply standard authorization requirements for verification information to all systems employing authentication service 102 as a means for authenticating and authorizing a user. Furthermore, although the authentication service 102 has been described and depicted as a separate entity from a system requiring authentication 308 that is accessible to the system via a network 118, it should be appreciated that in some embodiments, authenticating service 102 can be included within such a system requiring authentication 308.

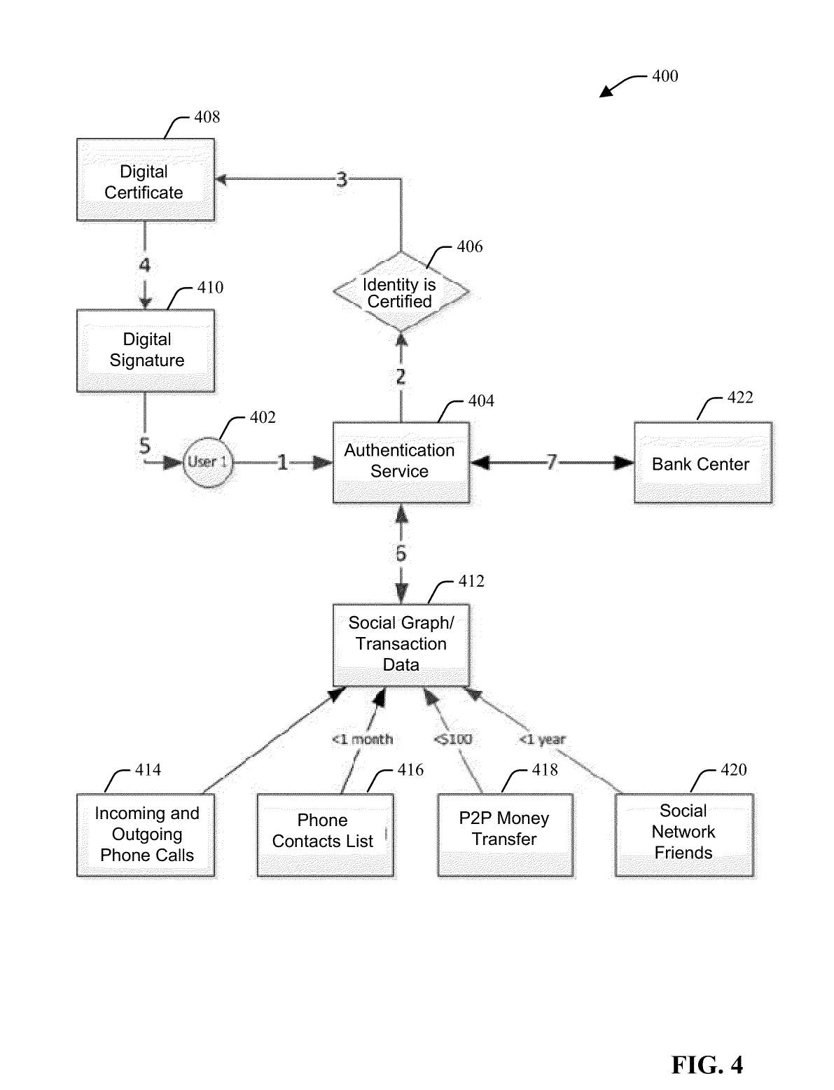

FIG. 4 presents a flow diagram 400 of an example authentication procedure in accordance with various aspects and embodiments described herein. The authentication procedure depicted in FIG. 4 involves authentication and authorization of a user 402 by authentication service 404 in order to gain access to an online banking center service 422. In an aspect, authentication service 404 can include one more aspects of authentication service 102. Repetitive description of like elements employed in respective embodiments of systems described herein are omitted for sake of brevity.

In procedure 400, user 402 is attempting to gain access to online banking center service 422. In order to access the bank center 422, the user must first prove identity to authentication service 404 and receive authorization by the authentication service 404. In an aspect, the user 402 can prove its identity to the authentication service 404 in various known ways. For example, the user can have his identity certified 406 by obtaining a digital certificate 408 and digital signature 410 for presentation to the authentication service 404.

In another aspect, in addition to or in the alternative of identity certification 406 via a digital certificate/digital signature, the user 402 can authenticate himself using social graph transaction history data 412. According to this aspect, the user can provide authentication service 404 social graph and social graph transaction history data and/or authorize the authentication service 404 access to information (e.g., phone records, social networking profile information, and etc.) that can be employed by authentication service 404 as social graph and/or social graph transaction history data.

For example, a user can provide the authentication service 404 his phone number and access to phone history data associated with the phone number and/or money transfer account information. According to this example, the authentication service 404 can receive social graph transaction data 412 that accounts for incoming and outgoing phone calls 414 associated with the phone number and peer to peer (P2P) money transfers 418 that were greater than $100 associated with the phone number and/or the money transfer account information. In another example, the user 402 can provide the authentication service 404 access to his phone contacts list 416 and/or social network friend information 420. According to this example, the authentication service 404 can receive data related to contact list friends that have been associated with the user greater than one month and social network friends that have been associated with the user greater than one year and employ this information to construct a social graph for the user 412. The authentication service 404 can then authenticate user 402 based on analysis of the social graph data and/or social graph transaction history data.

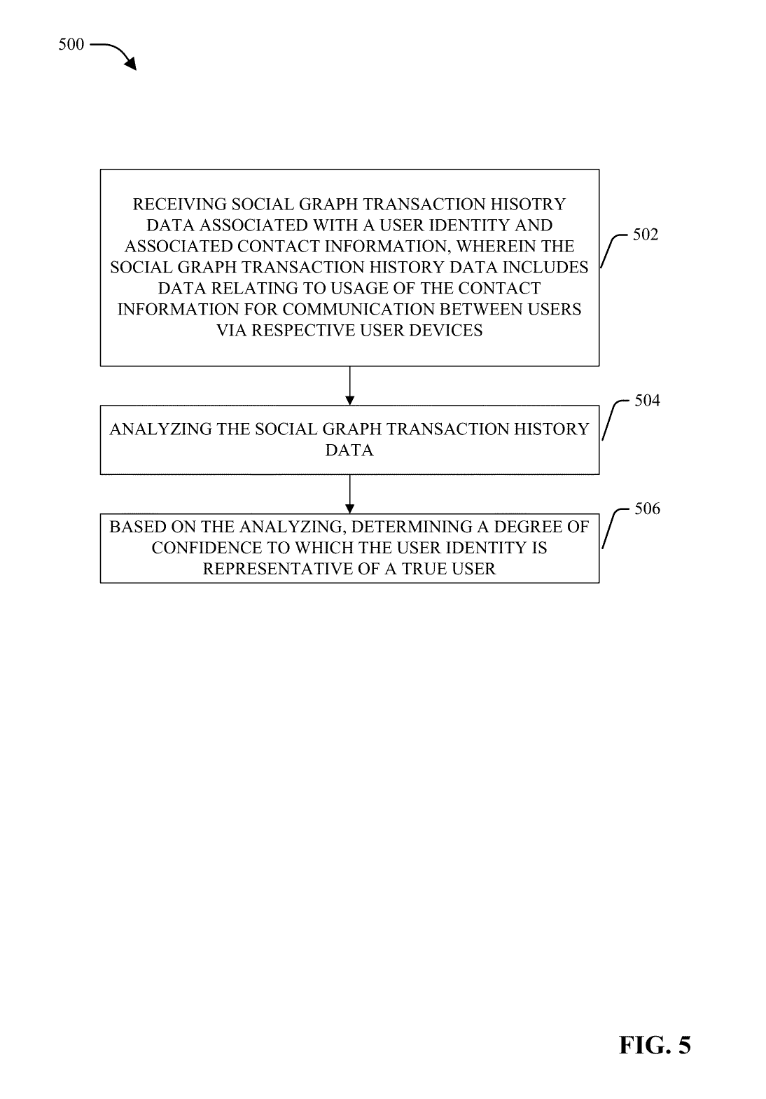

In view of the example systems and/or devices described herein, example methods that can be implemented in accordance with the disclosed subject matter can be further appreciated with reference to flowcharts in FIGS. 5-8. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 5 illustrates a flow chart of an example method 500 for authenticating a user based on social graph transaction history data in accordance with aspects described herein. At 502, social graph transaction history data associated with a user identity and associated contact information is received. The social graph transaction history data includes data relating to usage of the contact information for communication between users via respective user devices. At 504, the social graph transaction history data is analyzed and at 506, based on the analysis of the social graph transaction history data, a degree of confidence to which the user identity is representative of a true user is determined

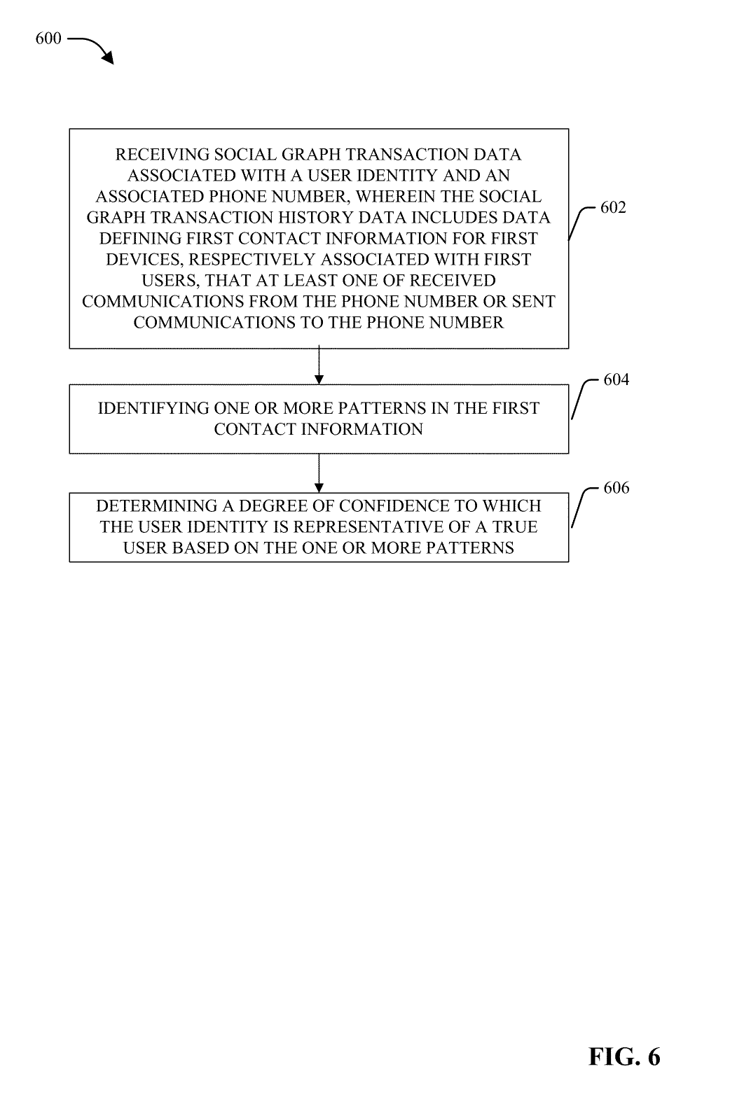

Referring next to FIG. 6, depicted is another flow chart of an example method 600 for authenticating a user based on social graph transaction history data. At 602, social graph transaction history data associated with a user identity and an associated phone number is received. The social graph transaction history data includes data defining first contact information for first devices, respectively associated with first users, that at least one of received communications from the phone number or sent communications to the phone number. At 604, one or more patterns in the first contact information are identified. At 606, a degree of confidence to which the user identity is representative of a true user is determined based on the one or more patterns.

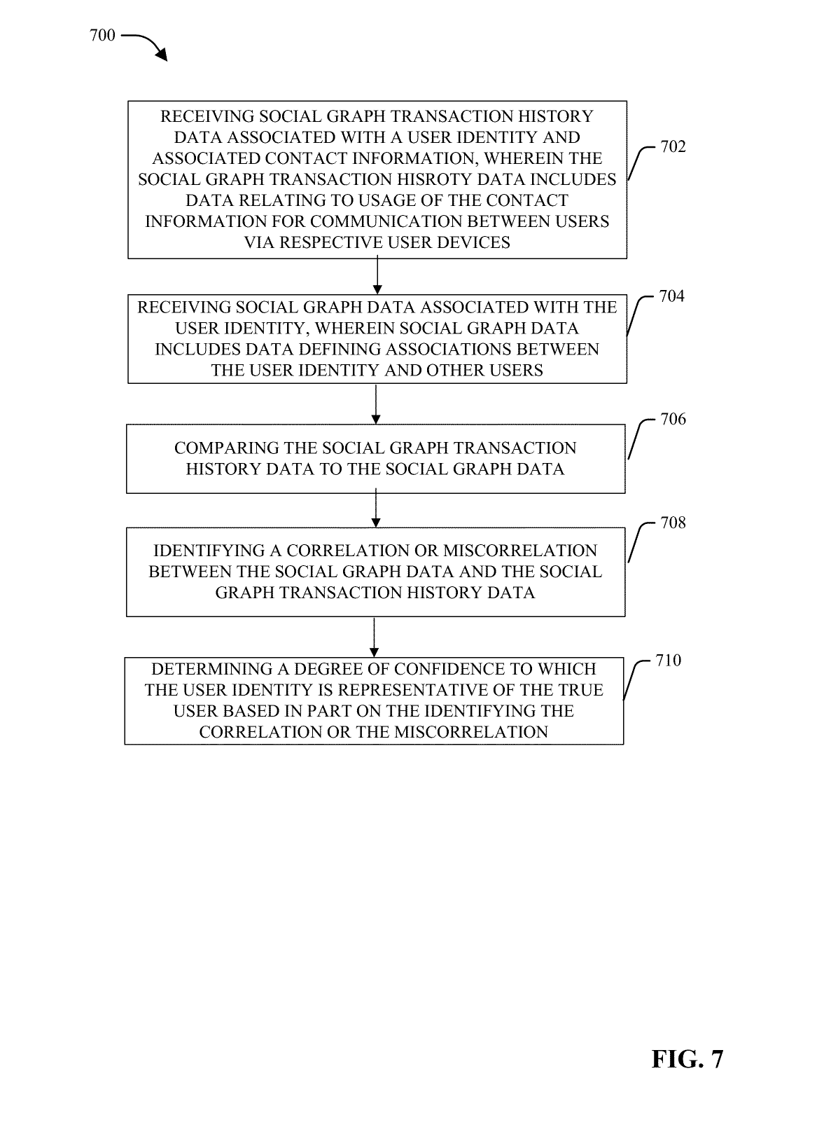

FIG. 7 presents another flow chart of an example method 700 for authenticating a user based on social graph transaction history data. At 702, social graph transaction history data associated with a user identity and associated contact information is received. The social graph transaction history data includes data relating to usage of the contact information for communication between users via respective user devices. At 704, social graph data associated with the user identity is received. The social graph data includes data defining associations between the user identity and other users. At 706, the social graph transaction history data is compared to the social graph data. At 708, a correlation or miscorrelation between the social graph transaction history data and the social graph data is identified. At 710, a degree of confidence to which the user identity is representative of the true user is determined based in part on the identifying the correlation or the miscorrelation.

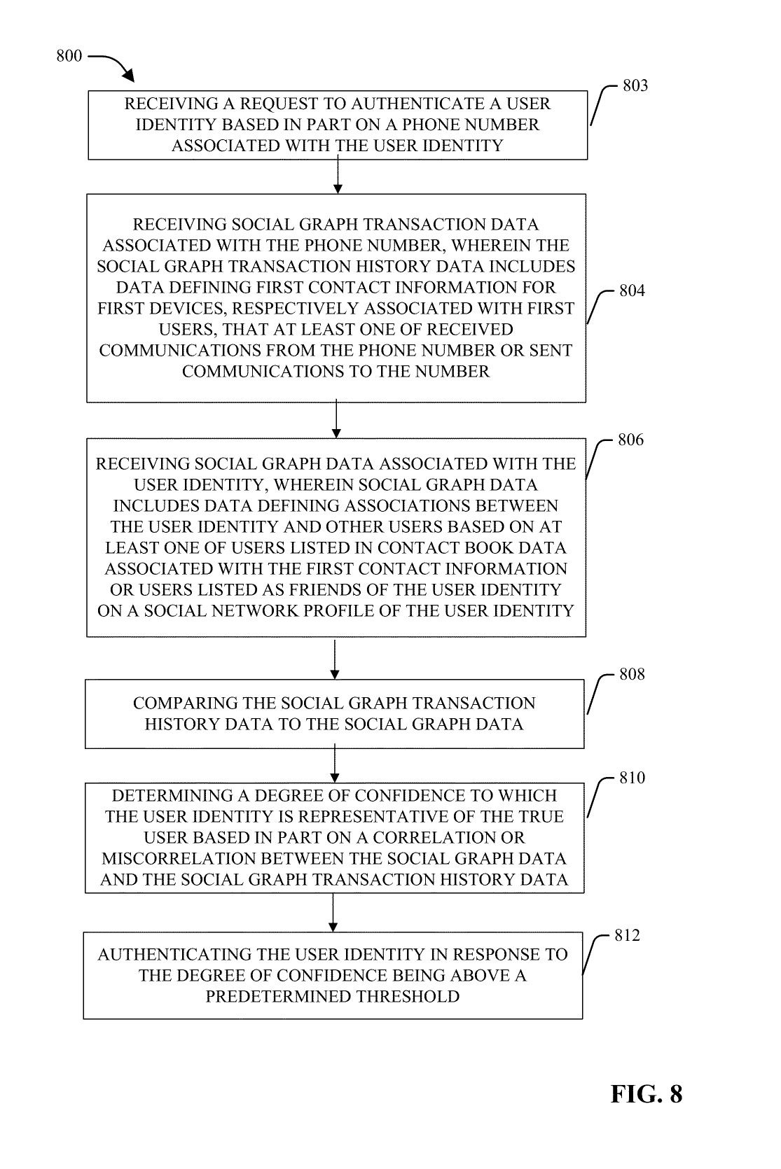

FIG. 8 presents another flow chart of an example method 800 for authenticating a user based on social graph transaction history data. At 802, a request to authenticate a user identity based in part on a phone number associated with the user identity is received. At 804, social graph transaction history data associated with the phone number is received. The social graph transaction history data includes data defining first contact information for first devices, respectively associated with first users, that at least one of received communications from the phone number or sent communications to the phone number. At 806, social graph data associated with the user identity is received. The social graph data includes data defining associations between the user identity and other users based on at least one of users listed in contact book data associated with the first contact information or users listed as friends of the user identity on a social network profile of the user identity. At 808, the social graph transaction history data is compared to the social graph data. At 810, a degree of confidence to which the user identity is representative of the true user is determined based in part on a correlation or miscorrelation between the social graph data and the social graph transaction history data. At 812, the user identity is authenticated in response to the degree of confidence being above a predetermined threshold.

### EXAMPLE OPERATING ENVIRONMENTS

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

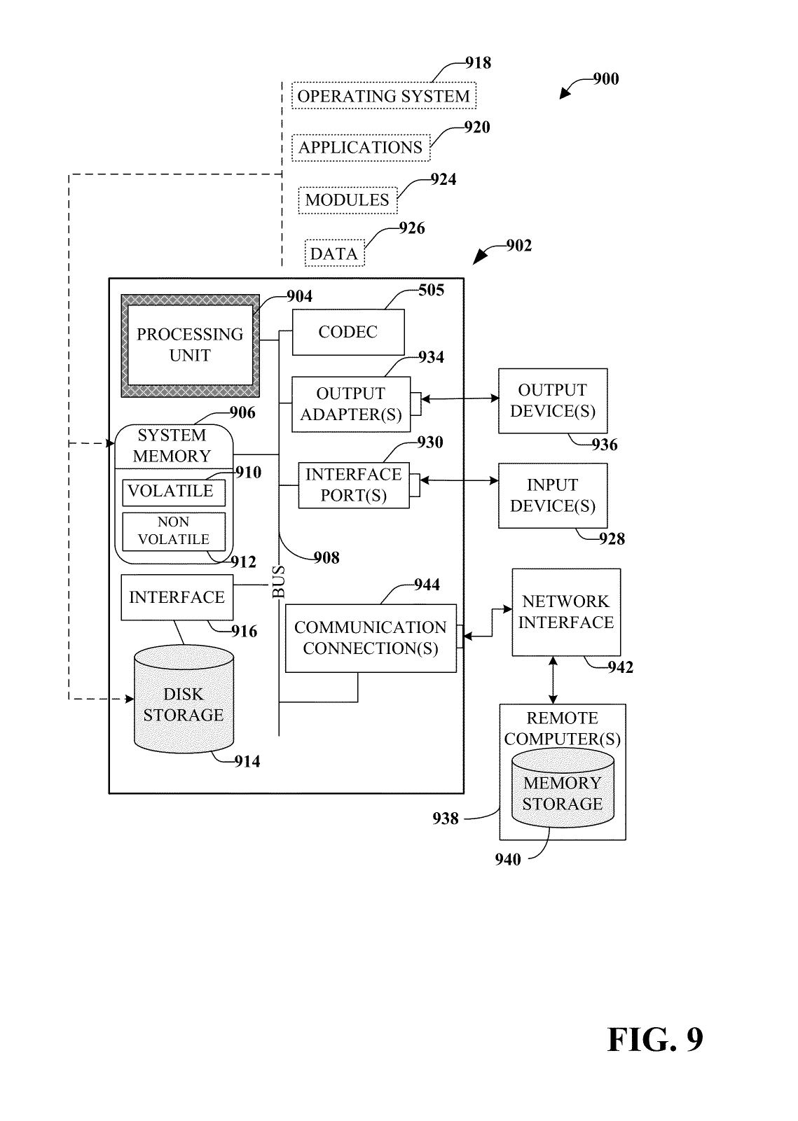

With reference to FIG. 9, a suitable environment 900 for implementing various aspects of the claimed subject matter includes a computer 902. The computer 902 includes a processing unit 904, a system memory 906, a codec 905, and a system bus 908. The system bus 908 couples system components including, but not limited to, the system memory 906 to the processing unit 904. The processing unit 904 can be any of various available processors. Dual microprocessors and other multiprocessor architectures also can be employed as the processing unit 904.

The system bus 908 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 906 includes volatile memory 910 and non-volatile memory 912. The basic input/output system (BIOS), containing the basic routines to transfer information between elements within the computer 902, such as during start-up, is stored in non-volatile memory 912. In addition, according to present innovations, codec 905 may include at least one of an encoder or decoder, wherein the at least one of an encoder or decoder may consist of hardware, a combination of hardware and software, or software. Although, codec 905 is depicted as a separate component, codec 905 may be contained within non-volatile memory 912. By way of illustration, and not limitation, non-volatile memory 912 can include read only memory (ROM), programmable ROM (PROM), electrically programmable ROM (EPROM), electrically erasable programmable ROM (EEPROM), or flash memory. Volatile memory 910 includes random access memory (RAM), which acts as external cache memory. According to present aspects, the volatile memory may store the write operation retry logic (not shown in FIG. 9) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 902 may also include removable/non-removable, volatile/non-volatile computer storage medium. FIG. 9 illustrates, for example, disk storage 914. Disk storage 914 includes, but is not limited to, devices like a magnetic disk drive, solid state disk (SSD) floppy disk drive, tape drive, Jaz drive, Zip drive, LS-70 drive, flash memory card, or memory stick. In addition, disk storage 914 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 914 to the system bus 908, a removable or non-removable interface is typically used, such as interface 916.

It is to be appreciated that FIG. 9 describes software that acts as an intermediary between users and the basic computer resources described in the suitable operating environment 900. Such software includes an operating system 918. Operating system 918, which can be stored on disk storage 914, acts to control and allocate resources of the computer system 902. Applications 920 take advantage of the management of resources by operating system 918 through program modules 924, and program data 926, such as the boot/shutdown transaction table and the like, stored either in system memory 906 or on disk storage 914. It is to be appreciated that the claimed subject matter can be implemented with various operating systems or combinations of operating systems.

A user enters commands or information into the computer 902 through input device(s) 928. Input devices 928 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 904 through the system bus 908 via interface port(s) 930. Interface port(s) 930 include, for example, a serial port, a parallel port, a game port, and a universal serial bus (USB). Output device(s) 936 use some of the same type of ports as input device(s). Thus, for example, a USB port may be used to provide input to computer 902, and to output information from computer 902 to an output device 936. Output adapter 934 is provided to illustrate that there are some output devices 936 like monitors, speakers, and printers, among other output devices 936, which require special adapters. The output adapters 934 include, by way of illustration and not limitation, video and sound cards that provide a means of connection between the output device 936 and the system bus 908. It should be noted that other devices and/or systems of devices provide both input and output capabilities such as remote computer(s) 938.

Computer 902 can operate in a networked environment using logical connections to one or more remote computers, such as remote computer(s) 938. The remote computer(s) 938 can be a personal computer, a server, a router, a network PC, a workstation, a microprocessor based appliance, a peer device, a smart phone, a tablet, or other network node, and typically includes many of the elements described relative to computer 902. For purposes of brevity, only a memory storage device 940 is illustrated with remote computer(s) 938. Remote computer(s) 938 is logically connected to computer 902 through a network interface 942 and then connected via communication connection(s) 944. Network interface 942 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 944 refers to the hardware/software employed to connect the network interface 942 to the bus 908. While communication connection 944 is shown for illustrative clarity inside computer 902, it can also be external to computer 902. The hardware/software necessary for connection to the network interface 942 includes, for exemplary purposes only, internal and external technologies such as, modems including regular telephone grade modems, cable modems and DSL modems, ISDN adapters, and wired and wireless Ethernet cards, hubs, and routers.

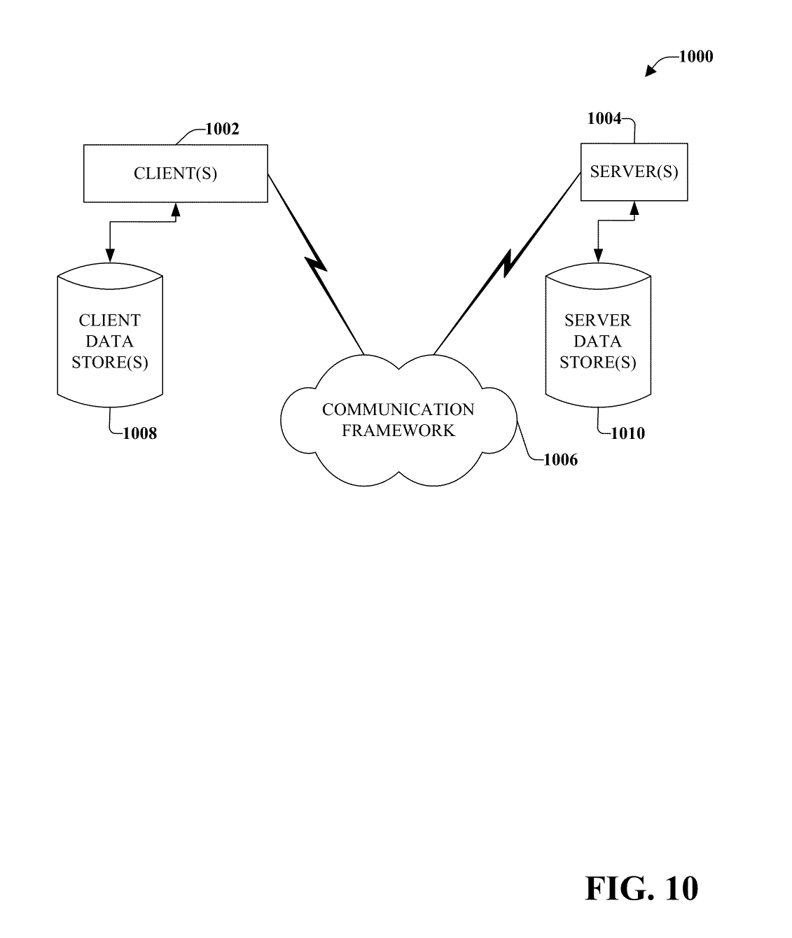

Referring now to FIG. 10, there is illustrated a schematic block diagram of a computing environment 1000 in accordance with this disclosure. The system 1000 includes one or more client(s) 1002 (e.g., laptops, smart phones, PDAs, media players, computers, portable electronic devices, tablets, and the like). The client(s) 1002 can be hardware and/or software (e.g., threads, processes, computing devices). The system 1000 also includes one or more server(s) 1004. The server(s) 1004 can also be hardware or hardware in combination with software (e.g., threads, processes, computing devices). The servers 1004 can house threads to perform transformations by employing aspects of this disclosure, for example. One possible communication between a client 1002 and a server 1004 can be in the form of a data packet transmitted between two or more computer processes wherein the data packet may include video data. The data packet can include a metadata, e.g., associated contextual information, for example. The system 1000 includes a communication framework 1006 (e.g., a global communication network such as the Internet, or mobile network(s)) that can be employed to facilitate communications between the client(s) 1002 and the server(s) 1004.

Communications can be facilitated via a wired (including optical fiber) and/or wireless technology. The client(s) 1002 include or are operatively connected to one or more client data store(s) 1008 that can be employed to store information local to the client(s) 1002 (e.g., associated contextual information). Similarly, the server(s) 1004 are operatively include or are operatively connected to one or more server data store(s) 1010 that can be employed to store information local to the servers 1004.

In one embodiment, a client 1002 can transfer an encoded file, in accordance with the disclosed subject matter, to server 1004. Server 1004 can store the file, decode the file, or transmit the file to another client 1002. It is to be appreciated, that a client 1002 can also transfer uncompressed file to a server 1004 and server 1004 can compress the file in accordance with the disclosed subject matter. Likewise, server 1004 can encode video information and transmit the information via communication framework 1006 to one or more clients 1002.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

What is claimed is:

1. A method, comprising:
employing at least one processor to execute computer executable instructions stored on at least one non-transitory computer readable medium to perform operations, comprising:
receiving social graph transaction history data associated with a user identity of a user and contact information associated with the user identity, wherein the social graph transaction history data includes data relating to usage of the contact information for communication between users via respective user devices;
analyzing the social graph transaction history data; and
based on the analyzing, determining a degree of confidence that the user identity is authentic.

2. The method of claim 1, wherein the determining the degree of confidence includes determining whether the user is responsible for generation of the social graph transaction history data.

3. The method of claim 1, wherein the contact information is a phone number and the user devices are mobile phones.

4. The method of claim 3, wherein the social graph transaction history data includes data defining first contact information for first devices, respectively associated with first users, that at least one of are determined to have received communications from the phone number or determined to have sent communications to the phone number, and the method further comprises:
identifying one or more patterns in the first contact information, wherein the determining the degree of confidence that the user identity is authentic is based on the one or more patterns.

5. The method of claim 4, wherein the communications determined to be received from the phone number or sent to the phone number include calls and the social graph transaction history data includes data defining duration of the calls, wherein the determining the degree of confidence that the user identity is authentic is further based on the duration of the calls.

6. The method of claim 4, wherein the social graph transaction history data further includes second contact information for second devices, respectively associated with second users, that at least one of are determined to have received communications from the first contact information or determined to have sent communications to the first contact information, and the method further comprises:
identifying one or more second patterns in the second contact information, wherein the determining the degree of confidence that the user identity is authentic is further based on the one or more second patterns in the second contact information.

7. The method of claim 4, wherein the social graph transaction history data further includes information defining one or more users who at least one of are determined to have received a data transfer based in part on the phone number or are determined to have sent a data transfer based in part on the phone number.

8. The method of claim 7, wherein the data transfer includes a money transfer and the social graph transaction history data further includes information defining an amount of the money transfer.

9. The method of claim 4, further comprising:
receiving social graph data associated with the user identity, wherein the social graph data includes data defining associations between the user identity and other users;
comparing the social graph data to the social graph transaction history data; and
identifying a correlation or miscorrelation between the social graph data and the social graph transaction history data, wherein the determining the degree of confidence that the user identity is authentic is further based on the correlation or the miscorrelation being identified.

10. The method of claim 9, wherein the receiving the social graph data includes receiving first contact book data associated with the contact information, wherein the first contact book data defines a first set of names and associated first contact information, wherein the comparing the social graph data to the social graph transaction history data includes comparing the first set of names and the associated first contact information to the first users.

11. The method of claim 9, wherein the receiving the social graph data includes:
accessing a social networking profile associated with the user identity; and
identifying friends associated with the user identity as defined in the social networking profile, and
wherein the comparing the social graph data to the social graph transaction history data includes comparing the friends to the first users.

12. The method of claim 11, wherein the identifying the correlation or miscorrelation is based on at least one of a number of friends that are common with the first users or a recency of addition of the friends that are common with the first users to the social networking profile.

13. The method of claim 1, further comprising:
receiving first contact book data associated with the contact information, wherein the first contact book data defines a first set of names and associated first contact information;
receiving second contact book data, wherein the second contact book data includes a plurality of secondary sets of names and associated secondary contact information associated with respective ones of the names and the associated first contact information of the first set; and
comparing the first contact book data with the second contact book data, wherein the determining the degree of confidence that the user identity is authentic is based on the comparing.

14. The method of claim 13, further comprising, determining a degree of similarity between the first set of names and the associated first contact information, and the plurality of secondary sets of names and the associated secondary contact information, wherein the determining the degree of confidence that the user identity is authentic is further based on the degree of similarity.

15. The method of claim 13, further comprising, identifying a degree of consistency between usage of a name and the associated first contact information included in the first set of names across the plurality of secondary sets of names and associated secondary contact information, wherein the determining the degree of confidence that the user identity is authentic is further based on the degree of similarity.

16. The method of claim 15, wherein the degree of the consistency between usage of the name includes the consistency of usage of a similar name or nickname.

17. The method of claim 13, further comprising, determining a recency of addition of the names and the associated contact information included in the first set, wherein the determining the degree of confidence that the user identity is authentic is further based on the recency of the addition.

18. The method of claim 1, further comprising:
receiving first contact book data associated with the contact information, wherein the first contact book data defines a first set of names and associated first contact information;
accessing a social networking profile associated with the user identity;
identifying friends associated with the user identity as defined in the social networking profile; and
comparing the friends to the first set of names and associated first contact information, wherein the determining the degree of confidence that the user identity is authentic is further based on the comparing.

19. The method of claim 18, further comprising, determining friends that are common with the first set of names and the associated first contact information, wherein the determining the degree of confidence that the user identity is authentic is further based on the friends that are determined to be common with the first set of names and the associated first contact information.

20. The method of claim 19, further comprising, determining a recency of addition of the friends that are common with the first set of names to the social networking profile, wherein the determining the degree of confidence that the user identity is authentic is further based the recency of the addition of the friends that are determined to be common with the first set of names.

21. The method of claim 1, further comprising:
identifying an authorized user that is associated with the user identity based on the contact information; and
sending a request to the authorized user to verify the user identity.

22. The method of claim 21, wherein the identifying the authorized user comprises identifying, based on a defined criterion, the authorized user represented in a contacts file associated with the contact information or a social networking profile associated with the user identity.

23. The method of claim 1, further comprising:
receiving a request to authenticate the user identity based in part on the contact information, wherein the determining the degree of confidence that the user identity is authentic is responsive to the receiving the request; and
authenticating the user identity in response to the degree of confidence being determined to satisfy a function of a defined threshold; or
denying authentication of the user identity in response to the degree of confidence being determined to fail to satisfy the function of the defined threshold.

24. The method of claim 1, wherein the contact information is an email address.

25. A system, comprising:
a memory having computer executable components stored thereon; and
a processor, communicatively coupled to the memory, configured to facilitate execution of the computer executable components, the computer executable components comprising:
a gathering component configured to receive social graph transaction history data associated with a user identity and associated contact information, wherein the social graph transaction history data includes data relating to usage of the contact information for communication between users via respective user devices; and
a verification component configured to analyze the social graph transaction history data to determine a degree of confidence that the user identity is not a false identity.

26. The system of claim 25, wherein the contact information is an email address.

27. The system of claim 25, wherein the contact information is a mobile phone number and the user devices are mobile phones.

28. The system of claim 27, wherein the social graph transaction history data includes data defining first contact information for first devices, respectively associated with first users, that at least one of received communications from the mobile phone number or sent communications to the mobile number, wherein the verification component is configured to determine the degree of confidence that the user identity is not the false identity based on the one or more patterns in the first contact information.

29. The system of claim 28, wherein the communications from the mobile number and sent to the mobile number include calls and the social graph transaction history data includes data defining duration of the calls, wherein the a verification component is configured to determine the degree of confidence that the user identity is not the false identity based on the duration of the calls.

30. The system of claim 28, wherein the social graph transaction history data further includes second contact information for second devices, respectively associated with second users, that at least one of received communications from the first contact information or sent communications to the first contact information, wherein the verification component is configured to determine the degree of confidence that the user identity is not the false identity based on one or more other patterns in the second contact information.

31. The system of claim 27, wherein the social graph transaction history data further includes information defining one or more users who at least one of received a data transfer based in part on the phone number or sent a data transfer based in part on the phone number.

32. The system of claim 31, wherein the data transfer includes a money transfer and the social graph transaction history data further includes information defining an amount of the money transfer.

33. The system of claim 27, wherein the gathering component is further configured to receive social graph data associated with the user identity, wherein social graph data includes data defining associations between the user identity and other users, and the verification component is further configured to compare the social graph data to the social graph transaction history data and determine the degree of confidence that the user identity is not the false identity based on a correlation or miscorrelation between the social graph data and the social graph transaction history data.

34. The system of claim 33, wherein the social graph data includes first contact set data associated with the contact information, wherein the first contact set data defines a first set of names and associated first contact information.

35. The system of claim 33, wherein the social graph data includes friends associated with the user identity as defined in a social networking profile associated with the user identity.

36. The system of claim 35, wherein the verification component is configured to identify the correlation or miscorrelation based on at least one of a number of friends that are common with the first users or a recency of addition of the friends that are common with the first users to the social networking profile.

37. The system of claim 25, wherein the gathering component is further configured to receive first contact set data associated with the contact information, wherein the first contact set data defines a first set of names and associated first contact information, receive second contact set data, wherein the second contact book data includes a plurality of secondary sets of names and associated secondary contact information associated with respective ones of the names and the associated first contact information of the first set, and the verification component is further configured to compare the first contact book data with the second contact book data to determine the degree of confidence that the user identity is not the false identity.

38. The system of claim 37, wherein the verification component is further configured to determine the degree of confidence that the user identity is not the false identity based on a degree of similarity between the first set of names and associated first contact information and the plurality of secondary sets of names and associated secondary contact information.

39. The system of claim 37, wherein the verification component is further configured to determine whether the degree of confidence that the user identity is not false based on consistent usage of a name and associated with first contact information included in the first set of names across the plurality of secondary sets of names and associated secondary contact information.

40. The system of claim 39, wherein the consistent usage of the name includes consistent usage of a similar name or nickname.

41. The system of claim 25, wherein the gathering component is further configured to receive first contact book data associated with the contact information, wherein the first contact book data defines a first set of names and associated first contact information and access a social networking profile associated with the user identity, and the verification component is further configured to determine whether the degree of confidence that the user identity is not the false identity as a function of similarity between friends included in the social networking profile and the first set of names and the associated first contact information.

42. The system of claim 41, wherein the verification component is further configured to determine whether the degree of confidence that the user identity is not the false identity as a function of a recency of addition of friends to the social networking profile that are included in the first set of names and the associated first contact information.

43. The system of claim 25, wherein the verification component is further configured to identify an authorized user that is associated with the user identity based on the contact information and send a request to the authorized user to verify the user identity.

44. The system of claim 43, wherein verification component is configured to identify the authorized user based in part on inclusion of the authorized user in a contact file associated with the contact information or a social networking profile associated with the user identity.

45. The system of claim 25, further comprising:
an authorization component configured to receive a request to authenticate the user identity based in part on the contact information, wherein the verification component is configured to determine the degree of confidence that the user identity is not the false identity in response to the request.

46. The system of claim 45, wherein the authorization component is configured to authenticate the user identity in response to the degree of confidence being above a predetermined threshold or deny authentication of the user identity in response to the degree of confidence being below the predetermined threshold.

47. A tangible computer-readable storage medium comprising computer-readable instructions that, in response to execution, cause a computing system to perform operations, comprising:
receiving social graph transaction history data associated with a user identity and associated contact information, wherein the social graph transaction history data includes data relating to usage of the contact information for communication between users via respective user devices;
receiving social graph data associated with the user identity, wherein the social graph data includes data defining associations between the user identity and other users;
comparing the social graph transaction history data to the social graph data;
identifying a correlation or miscorrelation between the social graph data and the social graph transaction history data; and
determining a degree of confidence that the user identity is representative of a true user based in part on the identifying the correlation or the miscorrelation.
